(19) United States
(12) Patent Application Publication
(10) Pub. No.: US 2025/0274016 A1
(43) Pub. Date: Aug. 28, 2025

(54) COOLING DEVICE AND FLYING OBJECT

(71) Applicant: HONDA MOTOR CO., LTD., Tokyo (JP)

(72) Inventor: Shingo Tanaka, Asaka-shi (JP)

(21) Appl. No.: 19/056,891

(22) Filed: Feb. 19, 2025

(30) Foreign Application Priority Data
Feb. 27, 2024 (JP) 2024-027047

(51) Int. Cl. H02K 9/197; B64C 29/00; B64D 27/34; B64D 33/08

(52) U.S. Cl. CPC H02K 9/197; B64D 33/08; B64C 29/0025; B64D 27/34

(57) ABSTRACT

A cooling device includes: a tubular member inserted into a hollow rotor shaft; and a cooling medium feed unit for causing a cooling medium to flow through a cooling medium flow path including a first partial flow path and a second partial flow path. The first partial flow path and the second partial flow path communicate with each other at a distal end of the tubular member, and the cross-sectional area of the second partial flow path at the distal end of the tubular member is larger than the cross-sectional area of the second partial flow path at a proximal end of the tubular member.

### CROSS-REFERENCE TO RELATED APPLICATIONS

This application is based upon and claims the benefit of priority from Japanese Patent Application No. 2024-027047 filed on Feb. 27, 2024, the contents of which are incorporated herein by reference.

### BACKGROUND OF THE INVENTION

### Field of the Invention

The present disclosure relates to a cooling device and a flying object.

### Description of the Related Art

In recent years, research and development have been conducted on technologies that contribute to energy efficiency in order to ensure that more people have access to affordable, reliable, sustainable and modern energy.

JP 2023-077131 A discloses a cooling mechanism for cooling a rotating electric machine mounted on a flying object. A cooling hole is formed from one end to the other end of a rotor shaft of the rotating electric machine. A part of a coolant supply pipe fixed to the flying object is inserted into the cooling hole. A cooling medium flows through the coolant supply pipe from the proximal end thereof located outside the cooling hole toward the distal end thereof located inside the cooling hole. The cooling medium that has flowed out from the distal end of the coolant supply pipe into the cooling hole flows to the outside of the rotating electric machine via a gap between the inner circumferential surface of the rotor shaft and the outer circumferential surface of the coolant supply pipe.

### SUMMARY OF THE INVENTION

In recent years, it has been required to satisfactorily cool the rotating electric machine with a simple configuration.

The present invention has the object of solving the aforementioned problem.

According to a first aspect of the present disclosure, there is provided a cooling device that cools a rotating electric machine including a stator, a rotor, and a rotor shaft configured to rotate integrally with the rotor, the cooling device comprising: a tubular member configured to be inserted into the rotor shaft that is hollow; and a cooling medium feed unit configured to cause a cooling medium to flow through a cooling medium flow path including a first partial flow path located between an inner circumferential surface of the rotor shaft and an outer circumferential surface of the tubular member, and a second partial flow path constituted by an internal hollow part of the tubular member, wherein the first partial flow path and the second partial flow path communicate with each other at a distal end of the tubular member, and a cross-sectional area of the second partial flow path at the distal end of the tubular member is larger than the cross-sectional area of the second partial flow path at a proximal end of the tubular member.

According to a second aspect of the present disclosure, there is provided a flying object comprising: the cooling device according to the first aspect; and the rotating electric machine according to the first aspect.

According to the above aspects, the rotating electric machine can be satisfactorily cooled with a simple configuration.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a flying object;

FIG. 2 is a diagram showing the configuration of a rotating electric machine and a cooling device according to a first embodiment;

FIG. 3 is a diagram showing the flow of a cooling medium when the rotating electric machine according to the first embodiment rotates in a first rotational direction;

FIG. 4 is a diagram showing the flow of the cooling medium when the rotating electric machine according to the first embodiment rotates in a second rotational direction;

FIG. 5 is a diagram showing the configuration of the rotating electric machine and the cooling device according to a second embodiment;

FIG. 6 is a diagram showing the flow of the cooling medium when the rotating electric machine according to the second embodiment rotates in the first rotational direction; and

FIG. 7 is a diagram showing the flow of the cooling medium when the rotating electric machine according to the second embodiment rotates in the second rotational direction.

### DETAILED DESCRIPTION OF THE INVENTION

### First Embodiment

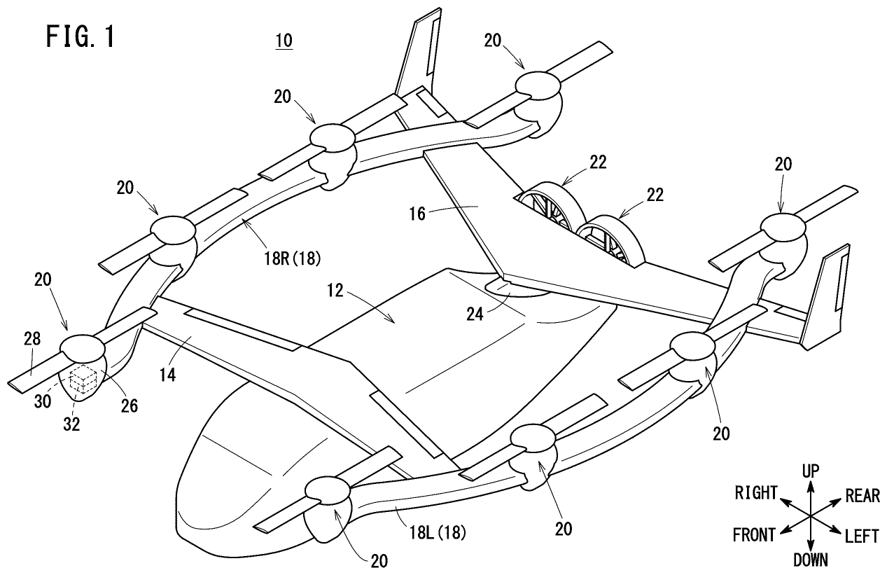

FIG. 1 is a perspective view of a flying object 10. In the present embodiment, the flying object 10 is an eVTOL aircraft, but is not limited thereto. For example, the flying object 10 may be a multicopter.

The flying object 10 includes a fuselage 12, a front wing 14, a rear wing 16, a plurality of booms 18, a plurality of takeoff and landing propeller devices 20, and a plurality of cruise propeller devices 22. The fuselage 12 is long in the front-rear direction. The front wing 14 is disposed forward of an intermediate portion of the fuselage 12 in the front-rear direction. The front wing 14 is connected to an upper portion of the fuselage 12. The rear wing 16 is disposed rearward of the intermediate portion of the fuselage 12 in the front-rear direction. The rear wing 16 is connected to the fuselage 12 via a pylon 24.

The plurality of booms 18 extend in the front-rear direction. The plurality of booms 18 include a right boom 18R and a left boom 18L. The right boom 18R is disposed on the right side of the fuselage 12. The right boom 18R is curved rightward in an arc shape. The right boom 18R is connected to a right wing tip of the front wing 14 and is connected to a right wing of the rear wing 16. The left boom 18L is disposed on the left side of the fuselage 12. The left boom 18L is curved leftward in an arc shape. The left boom 18L is connected to a left wing tip of the front wing 14 and is connected to a left wing of the rear wing 16. It should be noted that the right boom 18R and the left boom 18L may have a straight shape.

Each boom 18 includes the plurality of propeller devices 20. In the present embodiment, each boom 18 includes four propeller devices 20. It should be noted that each boom 18 may include two, three, five or more propeller devices 20. In each boom 18, the four propeller devices 20 are arranged at intervals in the extending direction of the boom 18.

Each of the plurality of propeller devices 20 includes an accommodating portion 26, a propeller 28, a rotating electric machine 30, and a cooling device 32, and the accommodating portions 26, the propellers 28, the rotating electric machines 30, and the cooling devices 32 respectively have the same structure. The accommodating portion 26 is configured to include a frame serving as a framework of the boom 18, and a fairing that covers the frame. The accommodating portion 26 accommodates the rotating electric machine 30 and the cooling device 32. The propeller 28 is located above the accommodating portion 26 and is rotatably attached to the accommodating portion 26. The rotating electric machine 30 rotates the propeller 28. The rotational directions of two or more propellers 28 of the plurality of propeller devices 20 may be different from each other. The cooling device 32 cools the rotating electric machine 30.

The fuselage 12 includes the plurality of propeller devices 22. In the present embodiment, the fuselage 12 includes two propeller devices 22. It should be noted that the fuselage 12 may include one or three or more propeller devices 22. The two propeller devices 22 are arranged side by side in the left-right direction at a rear end portion of the fuselage 12.

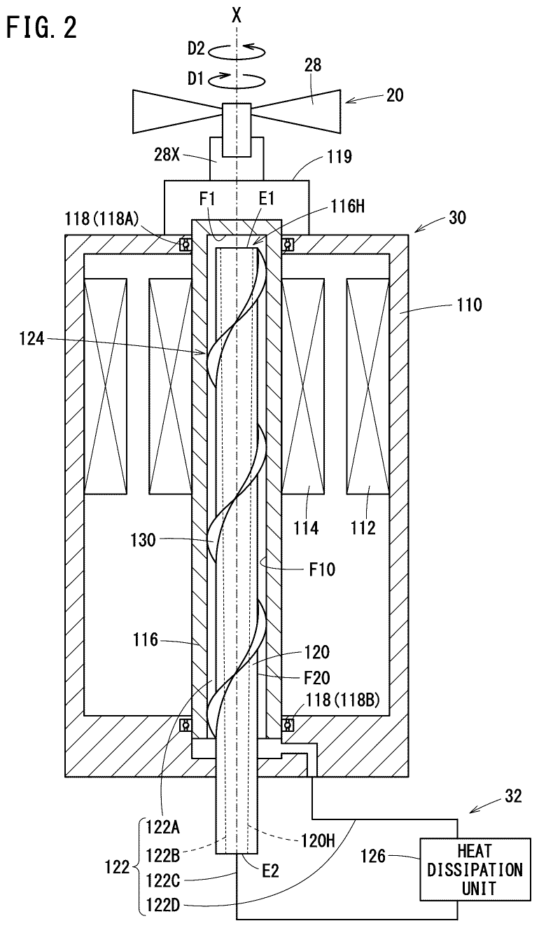

FIG. 2 is a diagram showing the configuration of the rotating electric machine 30 and the cooling device 32 according to the first embodiment. The rotating electric machine 30 is fixed in a state where an axis (rotation center) X of the rotating electric machine 30 lies along the vertical direction. For example, the rotating electric machine 30 is fixed to the frame of the accommodating portion 26. The rotating electric machine 30 is supplied with driving electric power from a power supply via an inverter circuit. The rotating electric machine 30 rotates about the axis X in a first rotational direction D1 or a second rotational direction D2 in response to the driving electric power. The rotating electric machine 30 includes a housing 110, a stator 112, a rotor 114, a rotor shaft 116, and two bearings 118.

The housing 110 is formed by combining a plurality of members. The housing 110 accommodates the stator 112, the rotor 114, and a part of the rotor shaft 116. The stator 112 is fixed to the housing 110. The rotor 114 is disposed inside the stator 112 and is fixed to the rotor shaft 116. The rotor shaft 116 is rotatably supported by the housing 110 via the two bearings 118. One of the two bearings 118 is a first bearing 118A that rotatably supports the rotor shaft 116 above the rotor 114. The other of the two bearings 118 is a second bearing 118B that rotatably supports the rotor shaft 116 below the rotor 114.

An upper end portion of the rotor shaft 116 is located within a gearbox 119. The gearbox 119 includes a plurality of gears (not shown) that couple the rotor shaft 116 of the rotating electric machine 30 to a propeller rotating shaft 28X provided on the propeller 28. The plurality of gears reduce the rotational speed of the rotor shaft 116 and transmit power to the propeller rotating shaft 28X. It should be noted that the gearbox 119 is installed on an upper surface of the housing 110, but the present disclosure is not limited thereto. For example, the gearbox 119 may be installed inside the housing 110.

The rotor shaft 116 is hollow. Specifically, the rotor shaft 116 is provided with a hollow portion 116H extending from a lower end of the rotor shaft 116 along the central axis of the rotor shaft 116. The lower end of the rotor shaft 116 is an open end where the hollow portion 116H is open. An upper end of the rotor shaft 116 is a closed end where the hollow portion 116H is not open.

The cooling device 32 is a device that cools the rotating electric machine 30. The cooling device 32 includes a tubular member 120, a cooling medium flow path 122, a cooling medium feed unit 124, and a heat dissipation unit 126.

The tubular member 120 is formed in a circular tube shape, but is not limited thereto. The tubular member 120 includes an internal hollow part 120H. The internal hollow part 120H penetrates the tubular member 120 along the direction in which the tubular member 120 extends.

The tubular member 120 is fixed to the frame or the like of the accommodating portion 26 (see FIG. 1) located outside the housing 110. The tubular member 120 penetrates the housing 110, and a part of the tubular member 120 is inserted into the hollow portion 116H of the rotor shaft 116. The tubular member 120 does not rotate even when the rotor shaft 116 rotates.

A distal end E1 of the tubular member 120 is an upper end of the tubular member 120 and is open in the hollow portion 116H of the rotor shaft 116. The distal end E1 of the tubular member 120 is located in the vicinity of a top surface F1 of the hollow portion 116H. More specifically, the distal end E1 of the tubular member 120 is located between the top surface F1 of the hollow portion 116H and a portion of the hollow portion 116H that is located inside the rotor 114. A proximal end E2 of the tubular member 120 is a lower end of the tubular member 120 and is located outside the housing 110.

The inner diameter of the tubular member 120 at the distal end E1 of the tubular member 120 is larger than the inner diameter of the tubular member 120 at the proximal end E2 of the tubular member 120. In other words, the cross-sectional area of the internal hollow part 120H at the distal end E1 of the tubular member 120 is larger than the cross-sectional area of the internal hollow part 120H at the proximal end E2 of the tubular member 120. In the present embodiment, the inner diameter of the tubular member 120 (the cross-sectional area of the internal hollow part 120H) increases from the proximal end E2 toward the distal end E1 of the tubular member 120, but the present disclosure is not limited thereto. For example, the inner diameter of the tubular member 120 (the cross-sectional area of the internal hollow part 120H) may increase from an intermediate position between the proximal end E2 and the distal end E1 of the tubular member 120 toward the distal end E1. In this case, the inner diameter of the tubular member 120 (the cross-sectional area of the internal hollow part 120H) from the proximal end E2 to the intermediate position is constant.

The cooling medium flow path 122 is formed so that the cooling medium circulates through the rotating electric machine 30 and the heat dissipation unit 126. The cooling medium flow path 122 includes a first partial flow path 122A, a second partial flow path 122B, a third partial flow path 122C, and a fourth partial flow path 122D.

The first partial flow path 122A is a portion of the cooling medium flow path 122 that is located between an inner circumferential surface F10 of the rotor shaft 116 and an outer circumferential surface F20 of the tubular member 120. The first partial flow path 122A is constituted by a gap between the inner circumferential surface F10 of the rotor shaft 116 and the outer circumferential surface F20 of the tubular member 120.

The second partial flow path 122B is a portion of the cooling medium flow path 122 that is located in the tubular member 120. The second partial flow path 122B is constituted by the internal hollow part 120H of the tubular member 120.

The third partial flow path 122C is a portion that connects the second partial flow path 122B and the heat dissipation unit 126. One end of the third partial flow path 122C communicates with the internal hollow part 120H at the proximal end E2 of the tubular member 120. The other end of the third partial flow path 122C communicates with one end of a pipe provided in the heat dissipation unit 126.

The fourth partial flow path 122D is a portion that connects the first partial flow path 122A and the heat dissipation unit 126 via the lower end portion of the rotor shaft 116. One end of the fourth partial flow path 122D communicates with the first partial flow path 122A. The other end of the fourth partial flow path 122D communicates with the other end of the pipe provided in the heat dissipation unit 126.

The cooling medium feed unit 124 is a unit for feeding the cooling medium. The cooling medium feed unit 124 includes a cooling medium feed rotating body 130 that rotates integrally with the rotor shaft 116 to feed the cooling medium. The cooling medium feed rotating body 130 is disposed in the first partial flow path 122A and extends helically in the direction in which the rotor shaft 116 extends. A part of the cooling medium feed rotating body 130 is fixed to the inner circumferential surface F10 of the rotor shaft 116. The cooling medium feed rotating body 130 and the outer circumferential surface F20 of the tubular member 120 are separated from each other with a slight gap therebetween.

The heat dissipation unit 126 is a unit for dissipating heat of the cooling medium to the outside. The heat dissipation unit 126 may be a radiator. The cooling medium is used to cool the rotating electric machine 30. The cooling medium may be a liquid such as a coolant or oil, but is not limited to a liquid.

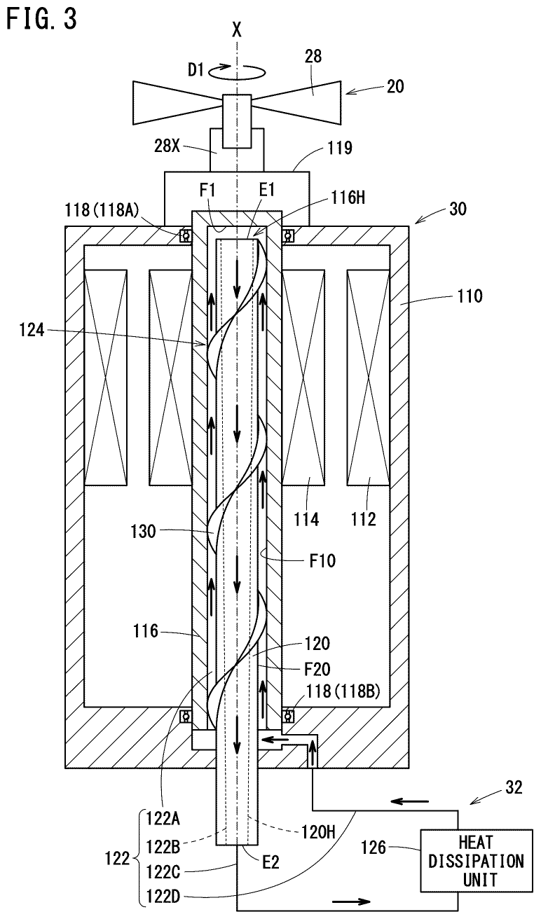

FIG. 3 is a diagram showing the flow of the cooling medium when the rotating electric machine 30 according to the first embodiment rotates in the first rotational direction D1.

When the rotor 114 of the rotating electric machine 30 rotates in the first rotational direction D1, the rotor shaft 116 to which the rotor 114 is fixed rotates in the first rotational direction D1. The rotor shaft 116 is coupled to the propeller rotating shaft 28X via the gears in the gearbox 119. Therefore, the propeller 28 rotates in the first rotational direction D1 in accordance with the rotation of the rotor shaft 116.

Further, a part of the cooling medium feed rotating body 130 is fixed to the rotor shaft 116. Therefore, the cooling medium feed rotating body 130 rotates in the first rotational direction D1 in the first partial flow path 122A in accordance with the rotation of the rotor shaft 116. When the cooling medium feed rotating body 130 rotates in the first rotational direction D1, the cooling medium in the first partial flow path 122A flows upward. The upward direction is a direction from the proximal end E2 of the tubular member 120 toward the distal end E1 of the tubular member 120. The cooling medium flowing upward through the first partial flow path 122A flows into the internal hollow part 120H of the tubular member 120 (the second partial flow path 122B) from the distal end E1 of the tubular member 120. The cooling medium that has flowed into the second partial flow path 122B flows downward through the second partial flow path 122B. The downward direction is a direction from the distal end E1 of the tubular member 120 toward the proximal end E2 of the tubular member 120. The cooling medium flowing downward through the second partial flow path 122B flows out into the third partial flow path 122C and reaches the heat dissipation unit 126. The cooling medium that has reached the heat dissipation unit 126 flows into the first partial flow path 122A from the lower end of the rotor shaft 116 through the fourth partial flow path 122D. In this manner, the cooling medium circulates through the rotating electric machine 30 and the heat dissipation unit 126.

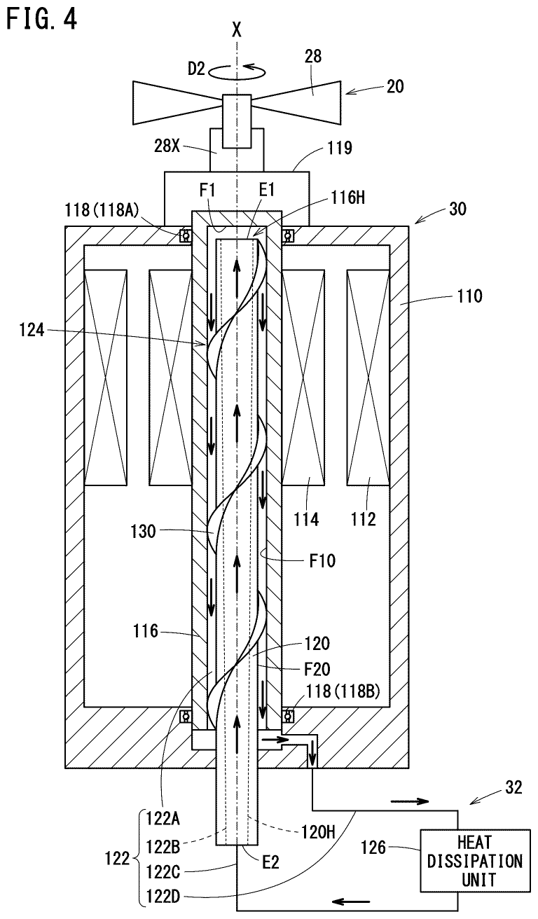

FIG. 4 is a diagram showing the flow of the cooling medium when the rotating electric machine 30 according to the first embodiment rotates in the second rotational direction D2.

When the rotor 114 of the rotating electric machine 30 rotates in the second rotational direction D2, the rotor shaft 116 to which the rotor 114 is fixed rotates in the second rotational direction D2. The propeller 28 rotates in the second rotational direction D2 in accordance with the rotation of the rotor shaft 116.

In addition, the cooling medium feed rotating body 130 rotates in the second rotational direction D2 in the first partial flow path 122A in accordance with the rotation of the rotor shaft 116. When the cooling medium feed rotating body 130 rotates in the second rotational direction D2, the cooling medium in the first partial flow path 122A flows downward. The cooling medium flowing downward through the first partial flow path 122A reaches the heat dissipation unit 126 through the fourth partial flow path 122D. The cooling medium that has reached the heat dissipation unit 126 flows into the second partial flow path 122B (the internal hollow part 120H) from the proximal end E2 of the tubular member 120 through the third partial flow path 122C. The cooling medium that has flowed into the second partial flow path 122B flows upward through the second partial flow path 122B, and flows out into the hollow portion 116H of the rotor shaft 116 from the distal end E1 of the tubular member 120. The cooling medium that has flowed out into the hollow portion 116H flows into the first partial flow path 122A. In this manner, the cooling medium circulates through the rotating electric machine 30 and the heat dissipation unit 126.

The rotating electric machine 30 generates heat in accordance with the rotation of the rotor 114 in the first rotational direction D1 or the second rotational direction D2. In particular, the amount of heat generated by the rotor 114 is larger than that generated by the other parts of the rotating electric machine 30 than the rotor 114. The heat generated from the rotor 114 is absorbed by the cooling medium flowing through the first partial flow path 122A, which is the portion of the cooling medium flow path 122 that is closest to the rotor 114. As a result, the rotor 114 is cooled. The cooling medium that has absorbed the heat is returned to the first partial flow path 122A after the heat thereof is dissipated in the heat dissipation unit 126.

As shown in FIG. 3, in a case where the rotor 114 rotates in the first rotational direction D1, then in the rotating electric machine 30, the cooling medium from which heat has been dissipated by the heat dissipation unit 126 first flows through the first partial flow path 122A. Thereafter, the cooling medium flows through the second partial flow path 122B (the internal hollow part 120H of the tubular member 120).

On the other hand, as shown in FIG. 4, in a case where the rotor 114 rotates in the second rotational direction D2, then in the rotating electric machine 30, the cooling medium from which heat has been dissipated by the heat dissipation unit 126 first flows through the second partial flow path 122B (the internal hollow part 120H of the tubular member 120). Thereafter, the cooling medium flows through the first partial flow path 122A.

As described above, in a case where the rotor 114 rotates in the first rotational direction D1, the cooling medium from which heat has been dissipated by the heat dissipation unit 126 immediately reaches the first partial flow path 122A. On the other hand, in a case where the rotor 114 rotates in the second rotational direction D2, the cooling medium from which heat has been dissipated by the heat dissipation unit 126 absorbs heat in the second partial flow path 122B and then reaches the first partial flow path 122A. Therefore, in a case where a simple tubular member having a constant inner diameter is used, the efficiency of cooling the rotor 114 when the rotor 114 rotates in the second rotational direction D2 is lower than the efficiency of cooling the rotor 114 when the rotor 114 rotates in the first rotational direction D1.

In contrast, in the present embodiment, the cross-sectional area of the second partial flow path 122B constituted by the internal hollow part 120H of the tubular member 120 is not constant along the direction in which the tubular member 120 extends. In other words, the cross-sectional area of the second partial flow path 122B at the distal end E1 of the tubular member 120 is larger than the cross-sectional area of the second partial flow path 122B at the proximal end E2 of the tubular member 120.

Consequently, the flow velocity of the cooling medium flowing through the internal hollow part 120H of the tubular member 120 from the proximal end E2 toward the distal end E1 is higher than the flow velocity of the cooling medium flowing through the internal hollow part 120H from the distal end E1 toward the proximal end E2. Therefore, it is possible to prevent the cooling medium from being heated in the second partial flow path 122B before reaching the first partial flow path 122A. Since the cooling medium can be prevented from being heated in the second partial flow path 122B before reaching the first partial flow path 122A, the difference between the efficiency of cooling the rotor 114 when the rotor 114 rotates in the second rotational direction D2 and the efficiency of cooling the rotor 114 when the rotor 114 rotates in the first rotational direction D1 can be reduced.

In the present embodiment, a first cooling performance and a second cooling performance are substantially the same at the rated output of the rotating electric machine 30. The first cooling performance is a cooling performance for the rotor 114 when the rotor 114 rotates in the first rotational direction D1. The second cooling performance is a cooling performance for the rotor 114 when the rotor 114 rotates in the second rotational direction D2. In the present embodiment, the inner diameter of the tubular member 120 (the cross-sectional area of the internal hollow part 120H) from the proximal end E2 toward the distal end E1 of the tubular member 120 is set so that the first cooling performance and the second cooling performance are substantially the same at the rated output of the rotating electric machine 30.

In addition, in the present embodiment, the cooling medium feed rotating body 130 disposed in the first partial flow path 122A rotates integrally with the rotor shaft 116. That is, the power for rotating the propeller 28 can be used to cause the cooling medium to flow through the cooling medium flow path 122. Further, since the cooling medium feed rotating body 130 is provided, a pump or the like for circulating the cooling medium is not necessary. Therefore, according to the present embodiment, the rotating electric machine 30 can be satisfactorily cooled with a simple configuration with a reduced number of components.

### Second Embodiment

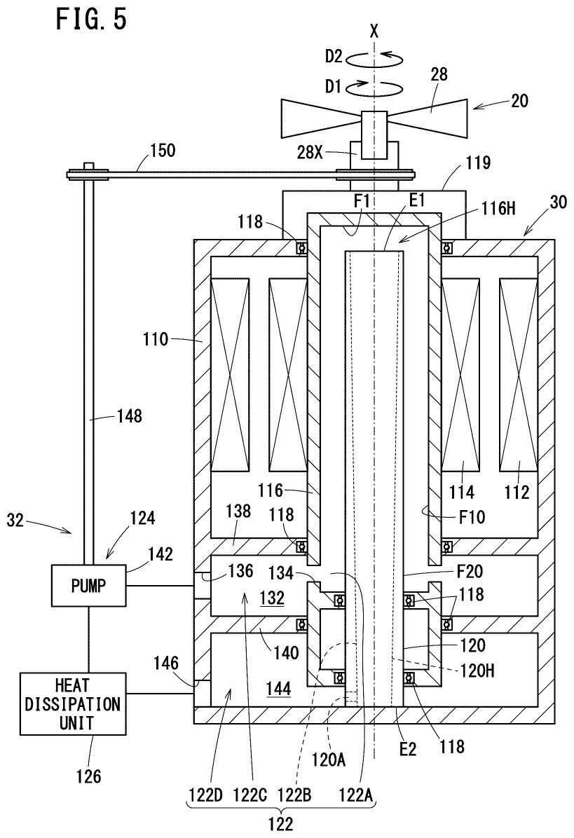

In the second embodiment, the description overlapping with that of the first embodiment will be omitted. FIG. 5 is a diagram showing the configuration of the rotating electric machine 30 and the cooling device 32 according to the second embodiment. In FIG. 5, the same components as those described in the first embodiment are denoted by the same reference numerals.

In the present embodiment, the proximal end E2 of the tubular member 120 is located inside the housing 110 and is fixed to an inner wall of the housing 110.

In the present embodiment, an opening 120A is formed in a side surface of the tubular member 120. The opening 120A is formed in a portion of the tubular member 120 that is located outside the rotor shaft 116. In other words, the opening 120A is located between the proximal end E2 of the tubular member 120 and the lower end of the rotor shaft 116. The number of the openings 120A may be one. Alternatively, a plurality of the openings 120A may be provided. In this case, the openings 120A are formed at intervals along the circumferential direction of the rotor shaft 116.

In the present embodiment, the third partial flow path 122C includes a first flow path space 132, a shaft opening 134, and a first connection port 136. The first flow path space 132 is a space surrounded by a first partition wall portion 138, a second partition wall portion 140, a side wall of the housing 110, and the rotor shaft 116. The first flow path space 132 communicates with the first partial flow path 122A via the shaft opening 134.

The first partition wall portion 138 is located above the second partition wall portion 140. The second partition wall portion 140 is located above the lower end of the rotor shaft 116. The first partition wall portion 138 and the second partition wall portion 140 each extend from the inner wall of the housing 110 toward an outer circumferential surface (an outer wall) of the rotor shaft 116. Bearings 118 are provided between an inner edge (a distal end) of the first partition wall portion 138 and the rotor shaft 116, and between an inner edge (a distal end) of the second partition wall portion 140 and the rotor shaft 116, respectively.

The shaft opening 134 is formed in a portion of the rotor shaft 116 that is located between the first partition wall portion 138 and the second partition wall portion 140. The shaft opening 134 is a through hole penetrating the rotor shaft 116. The number of the shaft openings 134 may be one. Alternatively, a plurality of the shaft openings 134 may be provided. In this case, the shaft openings 134 are formed at intervals along the circumferential direction of the rotor shaft 116.

The first connection port 136 is a port for allowing the cooling medium to flow into and out of the housing 110. The first connection port 136 is located between the first partition wall portion 138 and the second partition wall portion 140. The first connection port 136 is connected to a pump 142 via a pipe, and the pump 142 and the first flow path space 132 communicate with each other.

In the present embodiment, the fourth partial flow path 122D includes a second flow path space 144, the opening 120A, and a second connection port 146. The second flow path space 144 is a space surrounded by the second partition wall portion 140, the side wall of the housing 110, and a bottom wall of the housing 110. The second flow path space 144 communicates with the second partial flow path 122B via the opening 120A.

The second connection port 146 is a port for allowing the cooling medium to flow into and out of the housing 110. The second connection port 146 is located below the first connection port 136. The second connection port 146 is connected to the heat dissipation unit 126 via a pipe, and the heat dissipation unit 126 and the second flow path space 144 communicate with each other.

In the present embodiment, the cooling medium feed unit 124 includes the pump 142 instead of the cooling medium feed rotating body 130. The pump 142 is provided outside the housing 110. As described above, the pump 142 is connected to the first connection port 136 via the pipe. Further, the pump 142 is connected to the heat dissipation unit 126 via a pipe. The pump 142 includes a pump shaft 148. The pump 142 draws the cooling medium by the rotational motion of the pump shaft 148 and sends the drawn cooling medium.

The pump shaft 148 is coupled to the propeller rotating shaft 28X via a power transmission member 150. The power transmission member 150 is a chain, but is not limited thereto. For example, the power transmission member 150 may be a belt or a gear. The pump shaft 148 rotates in conjunction with the rotation of the propeller rotating shaft 28X. The pump shaft 148 rotates in the first rotational direction D1 in accordance with the rotation of the propeller rotating shaft 28X in the first rotational direction D1. On the other hand, the pump shaft 148 rotates in the second rotational direction D2 in accordance with the rotation of the propeller rotating shaft 28X in the second rotational direction D2.

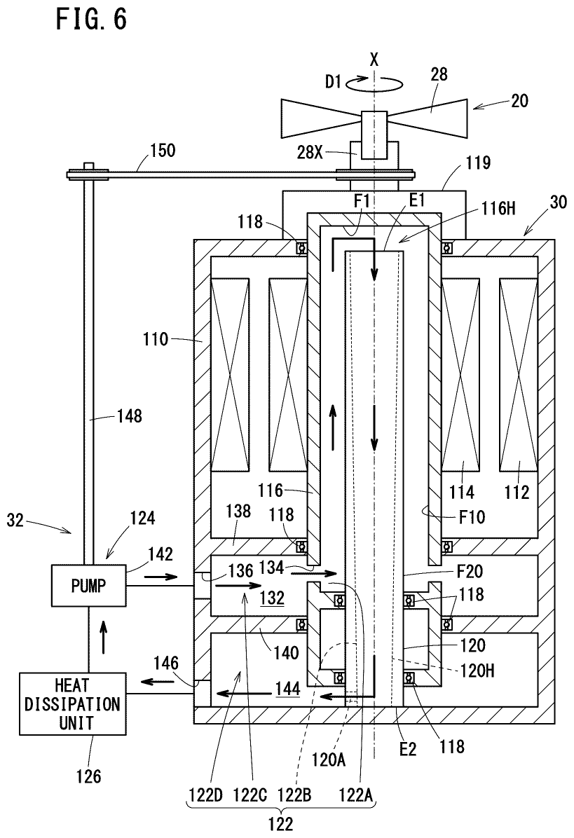

FIG. 6 is a diagram showing the flow of the cooling medium when the rotating electric machine 30 according to the second embodiment rotates in the first rotational direction D1.

When the rotor shaft 116 rotates in the first rotational direction D1, the propeller 28 rotates in the first rotational direction D1. The propeller rotating shaft 28X of the propeller 28 is coupled to the pump shaft 148 via the power transmission member 150. Therefore, the pump shaft 148 rotates in the first rotational direction D1 in accordance with the rotation of the propeller rotating shaft 28X.

When the pump shaft 148 rotates in the first rotational direction D1, the pump 142 sends the cooling medium to the first flow path space 132 via the first connection port 136. The cooling medium sent to the first flow path space 132 flows into the first partial flow path 122A via the shaft opening 134 and flows upward through the first partial flow path 122A. The cooling medium flowing upward through the first partial flow path 122A flows into the second partial flow path 122B from the distal end E1 of the tubular member 120, and flows downward through the second partial flow path 122B. The cooling medium flowing downward through the second partial flow path 122B flows out into the second flow path space 144 via the opening 120A, and reaches the heat dissipation unit 126 via the second connection port 146. The cooling medium that has reached the heat dissipation unit 126 is sent to the first flow path space 132 by the pump 142. In this manner, the cooling medium circulates through the rotating electric machine 30 and the heat dissipation unit 126.

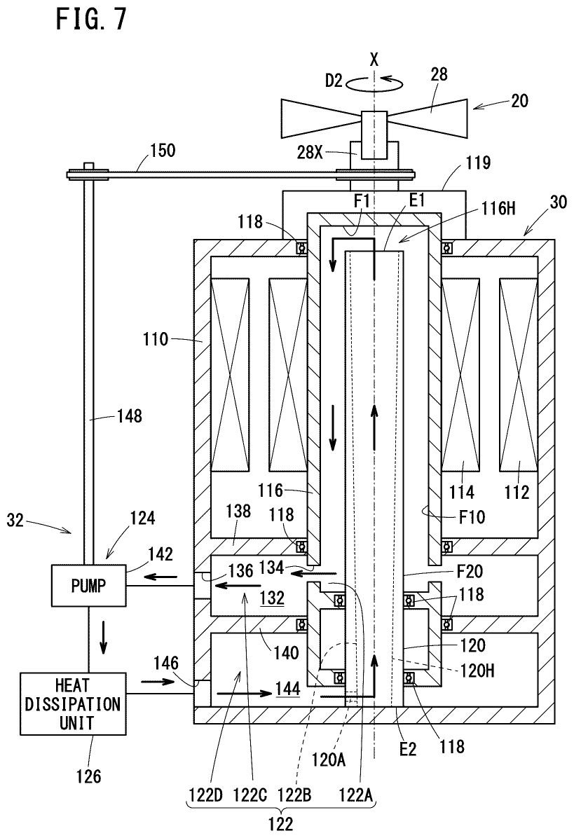

FIG. 7 is a diagram showing the flow of the cooling medium when the rotating electric machine 30 according to the second embodiment rotates in the second rotational direction D2.

When the rotor shaft 116 rotates in the second rotational direction D2, the propeller 28 rotates in the second rotational direction D2. The propeller rotating shaft 28X of the propeller 28 is coupled to the pump shaft 148 via the power transmission member 150. Therefore, the pump shaft 148 rotates in the second rotational direction D2 in accordance with the rotation of the propeller rotating shaft 28X.

When the pump shaft 148 rotates in the second rotational direction D2, the pump 142 sends the cooling medium to the heat dissipation unit 126. The cooling medium sent to the heat dissipation unit 126 flows into the second flow path space 144 via the second connection port 146. The cooling medium that has flowed into the second flow path space 144 flows into the second partial flow path 122B via the opening 120A, and flows upward through the second partial flow path 122B. The cooling medium flowing upward through the second partial flow path 122B flows into the first partial flow path 122A from the distal end E1 of the tubular member 120, and flows downward through the first partial flow path 122A. The cooling medium flowing downward through the first partial flow path 122A flows out into the first flow path space 132 via the shaft opening 134, and reaches the pump 142 via the first connection port 136. The cooling medium that has reached the pump 142 is sent to the heat dissipation unit 126 by the pump 142. In this manner, the cooling medium circulates through the rotating electric machine 30 and the heat dissipation unit 126.

In the present embodiment, the propeller rotating shaft 28X of the propeller 28 that rotates in conjunction with the rotation of the rotor shaft 116 is coupled to the pump shaft 148 of the pump 142 via the power transmission member 150. Therefore, the pump 142 sends the cooling medium to the cooling medium flow path 122 by the rotational force of the rotor shaft 116. Consequently, the cooling medium can be caused to flow through the cooling medium flow path 122 without separately providing a driving source of the pump 142. As a result, the rotating electric machine 30 can be cooled with a simple configuration.

As described above, in the above-described embodiments, the cross-sectional area of the second partial flow path 122B at the distal end E1 of the tubular member 120 is larger than the cross-sectional area of the second partial flow path 122B at the proximal end E2 of the tubular member 120.

Consequently, the flow velocity of the cooling medium flowing through the internal hollow part 120H of the tubular member 120 from the proximal end E2 toward the distal end E1 is higher than the flow velocity of the cooling medium flowing through the internal hollow part 120H from the distal end E1 toward the proximal end E2. In a case where the cooling medium flows through the internal hollow part 120H from the proximal end E2 toward the distal end E1, the flow velocity of the cooling medium flowing through the internal hollow part 120H is relatively high, and therefore, it is possible to prevent the cooling medium from being heated in the second partial flow path 122B before reaching the first partial flow path 122A. Since the cooling medium can be prevented from being heated in the second partial flow path 122B before reaching the first partial flow path 122A, the difference between the efficiency of cooling the rotor 114 when the rotor 114 rotates in the second rotational direction D2 and the efficiency of cooling the rotor 114 when the rotor 114 rotates in the first rotational direction D1 can be reduced. Therefore, the tubular member 120 can be shared regardless of the rotational direction of the propeller 28. As a result, cooling can be satisfactorily performed with a simple configuration with a reduced number of components.

The following supplementary notes are further disclosed in relation to the above-described embodiments.
Supplementary Note 1

The cooling device (32) of the present disclosure is a cooling device that cools the rotating electric machine (30) including the stator (112), the rotor (114), and the rotor shaft (116) configured to rotate integrally with the rotor, the cooling device including: the tubular member (120) configured to be inserted into the rotor shaft that is hollow; and the cooling medium feed unit (124) configured to cause the cooling medium to flow through the cooling medium flow path (122) including the first partial flow path (122A) located between the inner circumferential surface (F10) of the rotor shaft and the outer circumferential surface (F20) of the tubular member, and the second partial flow path (122B) constituted by the internal hollow part (120H) of the tubular member, wherein the first partial flow path and the second partial flow path communicate with each other at the distal end (E1) of the tubular member, and the cross-sectional area of the second partial flow path at the distal end of the tubular member is larger than the cross-sectional area of the second partial flow path at the proximal end (E2) of the tubular member.
Supplementary Note 2

In the cooling device according to Supplementary Note 1, the cross-sectional area of the second partial flow path may increase from the proximal end toward the distal end.
Supplementary Note 3

In the cooling device according to Supplementary Note 1, the cooling medium feed unit may cause the cooling medium to flow through the cooling medium flow path in a manner so that the cooling medium passing through the first partial flow path reaches the second partial flow path in accordance with rotation of the rotor in the first rotational direction (D1), and cause the cooling medium to flow through the cooling medium flow path in a manner so that the cooling medium passing through the second partial flow path reaches the first partial flow path in accordance with the rotation of the rotor in the second rotational direction (D2) opposite to the first rotational direction.
Supplementary Note 4

In the cooling device according to Supplementary Note 3, the cooling performance for the rotor when the rotor rotates in the first rotational direction and the cooling performance for the rotor when the rotor rotates in the second rotational direction may be substantially equal to each other at the rated output of the rotating electric machine.
Supplementary Note 5

In the cooling device according to Supplementary Note 1, the cooling medium feed unit may include the cooling medium feed rotating body (130) that is disposed in the first partial flow path and is configured to rotate integrally with the rotor shaft.
Supplementary Note 6

In the cooling device according to Supplementary Note 5, the cooling medium feed rotating body may extend helically in the direction in which the rotor shaft extends.
Supplementary Note 7

In the cooling device according to Supplementary Note 1, the cooling medium feed unit may include the pump (142) configured to send the cooling medium to the cooling medium flow path using a rotational force of the rotor shaft.
Supplementary Note 8

The flying object (10) of the present disclosure includes the cooling device according to any one of Supplementary Notes 1 to 7, and the rotating electric machine according to any one of Supplementary Notes 1 to 7.
Supplementary Note 9

In the flying object according to Supplementary Note 8, the rotating electric machine comprises a plurality of the rotating electric machines, the cooling device comprises a plurality of the cooling devices, and the cooling devices provided for the respective rotating electric machines may have an identical structure.
Supplementary Note 10

The flying object according to Supplementary Note 9 may further include two or more propellers (28) configured to rotate in different rotational directions.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A cooling device that cools a rotating electric machine including a stator, a rotor, and a rotor shaft configured to rotate integrally with the rotor, the cooling device comprising:
a tubular member configured to be inserted into the rotor shaft that is hollow; and
a cooling medium feed unit configured to cause a cooling medium to flow through a cooling medium flow path including a first partial flow path located between an inner circumferential surface of the rotor shaft and an outer circumferential surface of the tubular member, and a second partial flow path constituted by an internal hollow part of the tubular member,
wherein the first partial flow path and the second partial flow path communicate with each other at a distal end of the tubular member, and
a cross-sectional area of the second partial flow path at the distal end of the tubular member is larger than the cross-sectional area of the second partial flow path at a proximal end of the tubular member.

2. The cooling device according to claim 1, wherein
the cross-sectional area of the second partial flow path increases from the proximal end toward the distal end.

3. The cooling device according to claim 1, wherein
the cooling medium feed unit is configured to:
cause the cooling medium to flow through the cooling medium flow path in a manner so that the cooling medium passing through the first partial flow path reaches the second partial flow path in accordance with rotation of the rotor in a first rotational direction; and
cause the cooling medium to flow through the cooling medium flow path in a manner so that the cooling medium passing through the second partial flow path reaches the first partial flow path in accordance with the rotation of the rotor in a second rotational direction opposite to the first rotational direction.

4. The cooling device according to claim 3, wherein
a cooling performance for the rotor when the rotor rotates in the first rotational direction and the cooling performance for the rotor when the rotor rotates in the second rotational direction are substantially equal to each other at a rated output of the rotating electric machine.

5. The cooling device according to claim 1, wherein
the cooling medium feed unit includes a cooling medium feed rotating body that is disposed in the first partial flow path and is configured to rotate integrally with the rotor shaft.

6. The cooling device according to claim 5, wherein
the cooling medium feed rotating body extends helically in a direction in which the rotor shaft extends.

7. The cooling device according to claim 1, wherein
the cooling medium feed unit includes a pump configured to send the cooling medium to the cooling medium flow path using a rotational force of the rotor shaft.

8. A flying object comprising:
the cooling device according to claim 1; and
the rotating electric machine according to claim 1.

9. The flying object according to claim 8, wherein
the rotating electric machine comprises a plurality of the rotating electric machines, the cooling device comprises a plurality of the cooling devices, and the cooling devices provided for the respective rotating electric machines have an identical structure.

10. The flying object according to claim 9, further comprising two or more propellers configured to rotate in different rotational directions.
